(19) United States
(12) Patent Application Publication
(10) Pub. No.: US 2013/0008689 A1
(43) Pub. Date: Jan. 10, 2013

(54) COVERING MATERIAL FOR RECTANGULAR ELECTRIC WIRE, RECTANGULAR ELECTRIC WIRE COVERED WITH COVERING MATERIAL FOR RECTANGULAR ELECTRIC WIRE, AND ELECTRICAL DEVICE USING THE SAME

(75) Inventors: Kiichiro Matsushita, Osaka (JP); Yoshihisa Furuta, Osaka (JP); Kazunori Hayashi, Fukui (JP); Yoshinori Tanaka, Fukui (JP); Akihiro Oohashi, Fukui (JP); Kayoko Takayanagi, Fukui (JP); Kazumasa Mukobata, Fukui (JP)

(73) Assignees: NITTOSHINKO CORPORATION, Sakai-shi, Fukui (JP); NITTO DENKO CORPORATION, Ibaraki-shi, Osaka (JP)

(21) Appl. No.: 13/635,814

(22) PCT Filed: Dec. 16, 2011
(86) PCT No.: PCT/JP2011/079237

§ 371 Date: Sep. 18, 2012

(30) Foreign Application Priority Data
Dec. 25, 2010 (JP) 2010-289026
Nov. 25, 2011 (JP) 2011-257881

(51) Int. Cl. H01B 7/02

(52) U.S. Cl. 174/119 R

(57) ABSTRACT

The covering material for a rectangular electric wire of the present invention is a covering adhesive tape for covering a rectangular electric wire, wherein a viscoelastic material layer is disposed on one side of the backing of the covering material. In particular, in the covering material for a rectangular electric wire of the present invention, the viscoelastic material layer preferably includes a silicone-based adhesive agent composition, and the backing preferably includes a polyimide resin.

### FIELD OF THE INVENTION

The present invention relates to a covering material for a rectangular electric wire to cover a rectangular electric wire therewith, a rectangular electric wire covered with the covering material for a rectangular electric wire, and an electrical device using the covered rectangular electric wire.

### BACKGROUND ART

Rectangular electric wires have been used in coil devices such as rotary machines and magnets used in various electrical devices, and there have been used rectangular electric wires obtained by covering rectangular electric wire materials made of copper, copper alloys, aluminum, aluminum alloys and combinations of these metals with appropriate insulating materials. In recent years, various superconducting materials such as bismuth-based, yttrium-based and niobium-based superconducting materials have been developed, and superconducting magnets, superconducting coils and the like have been developed by using as rectangular electric wires the superconducting wires using these materials.

These rectangular electric wires are used as covered with appropriate insulating materials for the purpose of insulating electric wires from each other. For example, it has been known that naked rectangular electric wires are covered with insulating film tapes in a spirally wound manner (for example, see, Patent Document 1). It has also been known that rectangular conductors are covered with resin insulating covering materials (for example, see, Patent Document 2).

### PRIOR ART DOCUMENTS

### Patent Documents

Patent Document 1: Japanese Patent Laid-Open No. 2000-4552

Patent Document 2: Japanese Patent Laid-Open No. 2003-272916

### DISCLOSURE OF THE INVENTION

### Problems to be Solved by the Invention

However, in the insulation method described in Patent Document 1, a lap portion in which the insulating film tape partially overlap with itself is required to be formed for the purpose of certainly achieving insulation; however, a space occurs in the lap portion and the lap portion sometimes includes air bubbles due to incomplete adhesion of the insulating film tape to the naked rectangular electric wire. In a portion involving such a space or such air bubbles, electric field is concentrated and consequently feeble discharge occurs. Such discharge is referred to as partial discharge, degrades the insulator and sometimes results in dielectric breakdown in a long period of time. In particular, the present inventors have verified that in the case of rectangular electric wires used in liquid nitrogen as it is the case for superconducting wires, the decrease of the partial discharge onset voltage due to the air bubbles penetrating into the lap portion is remarkable.

In the insulation method described in Patent Document 2, a rectangular electric wire is covered with a molten thermoplastic resin, the temperature of the molten thermoplastic resin is considerably high depending on the type of the resin material, and hence there is an adverse possibility that the properties of the wire material are degraded.

The present invention has been achieved in view of the aforementioned circumstances, and an object of the present invention is to provide a covering material for a rectangular electric wire capable of simply performing insulation covering of a rectangular electric wire at room temperature, and in particular, capable of covering without forming the air bubbles and the space even when the covering material is spirally wound while the lap portion is being formed.

### Means for Solving Problems

The present inventors have perfected the present invention by discovering that the aforementioned technical problem can be solved by disposing a viscoelastic material layer on one side of a backing in the covering material for covering the rectangular electric wire.

In other words, the covering material for a rectangular electric wire of the present invention is a covering adhesive tape for covering a rectangular electric wire wherein a viscoelastic material layer is disposed on one side of the backing of the covering adhesive tape.

In particular, in the covering material for a rectangular electric wire of the present invention, the viscoelastic material layer preferably includes a silicone-based viscoelastic adhesive agent composition and the backing preferably includes a polyimide resin.

Moreover, the covering material for a rectangular electric wire of the present invention preferably has an adhesive force (180° peeling, tensile rate: 300 mm/min) to a SUS304 steel plate of 0.01 to 10 N/20 mm and preferably has a low-speed rewinding force (tensile rate: 300 mm/min) of 0.05 to 10 N/20 mm.

The present invention also provides a rectangular electric wire, wherein the rectangular electric wire is covered with the covering material for a rectangular electric wire. The rectangular electric wire is preferably a superconducting wire.

The present invention also provides an electrical device using the rectangular electric wire covered with the covering material for a rectangular electric wire.

### Advantageous Effects of Invention

The covering material for a rectangular electric wire of the present invention has the aforementioned constitution, and hence allows a rectangular electric wire to be simply covered with the covering material for a rectangular electric wire under a room temperature condition, and allows the occurrence of the degradation of the rectangular electric wire due to heat to be suppressed. Also, even when the covering adhesive tape (the covering material for a rectangular electric wire) is spirally wound while the lap portion is being formed, the viscoelastic layer fills the space in the lap portion and the covering material adheres to the electric wire, so that the penetration of the air bubbles into the lap portion can be prevented. Consequently, discharge from the lap portion or the portion holding the air bubbles is suppressed and hence a high dielectric breakdown voltage can be attained.

### BRIEF DESCRIPTION OF DRAWINGS

FIG. 1 is a schematic side view illustrating an embodiment of the covering material for a rectangular electric wire of the present invention.

FIG. 2 is a schematic perspective view illustrating an embodiment of a rectangular electric wire covered with the covering material for a rectangular electric wire of the present invention.

FIG. 3 is an illustration of the evaluation method of the partial discharge onset voltage of a rectangular electric wire.

FIG. 4 is a schematic perspective view illustrating an embodiment of a coil as an example of an electrical device.

### DESCRIPTION OF EMBODIMENTS

The covering material for a rectangular electric wire of the present invention has a constitution in which a viscoelastic layer is disposed on one side of the backing thereof.

(Backing)

In the present invention, the backing is not particularly limited as long as the backing has the properties such as insulation property, radiation resistance and heat resistance; examples of the backing include polyimide resin, polyether resin, polyether ether ketone resin, polyether imide resin and polyamide-imide resin. These resins may be used each alone or can also be used as mixtures of two or more thereof.

In the present invention, among these resins, polyimide resin is particularly preferably used as the backing. Polyimide resin is a nonflammable material as well as a heat resistant material; hence, because of having an excellent flame retardancy as an insulating material used in an electrical device, polyimide resin has excellent properties as the backing of the covering material of the present invention.

Polyimide resin can be obtained by heretofore known or conventional methods. For example, polyimide can be obtained by allowing an organic tetracarboxylic acid dianhydride and a diamino compound (diamine) to react with each other to synthesize a polyimide precursor (polyamide acid), and by dehydrating and ring-closing by dehydration the polyimide precursor.

Examples of the organic tetracarboxylic acid dianhydride include pyromellitic acid dianhydride, 3,3′,4,4′-biphenyl tetracarboxylic acid dianhydride, 2,2-bis(2,3-dicarboxyphenyl)-1,1,1,3,3,3-hexafluoropropane dianhydride, 2,2-bis(3,4-dicarboxylphenyl)-1,1,1,3,3,3-hexafluoropropane dianhydride, 3,3′,4,4′-benzophenone tetracarboxylic acid dianhydride, bis(3,4-dicarboxyphenyl)ether dianhydride and bis(3,4-dicarboxyphenyl)sulfone dianhydride. These organic tetracarboxylic acid dianhydrides may be used each alone or can also be used as mixtures of two or more thereof.

Examples of the diamino compound include m-phenylenediamine, p-phenylenediamine, 3,4-diaminodiphenyl ether, 4,4′-diaminodiphenyl ether, 4,4′-diaminodiphenyl sulfone, 3,3′-diaminodiphenyl sulfone, 2,2-bis(4-aminophenoxyphenyl)propane, 2,2-bis(4-aminophenoxyphenyl)hexafluoropropane, 1,3-bis(4-aminophenoxy)benzene, 1,4-bis(4-aminophenoxy)benzene, 2,4-diaminotoluene, 2,6-diaminotoluene, diaminodiphenylmethane, 2,2′-dimethyl-4,4′-diaminobiphenyl and 2,2′-bis(trifluoromethyl)-4,4′-diaminobiphenyl. These diamino compounds may be used each alone or as mixtures of two or more thereof.

For the polyimide resin used in the present invention, it is preferable to use pyromellitic acid dianhydride or 3,3′,4,4′-biphenyl tetracarboxylic acid dianhydride as an organic tetracarboxylic acid dianhydride, and p-phenylenediamine or 4,4′-diaminodiphenyl ether as the diamino compound. As such polyimide resins, commercially available resins such as “Kapton” (manufactured by Du Pont-Toray Co., Ltd.) and “Upilex” (manufactured by Ube Industries, Ltd.) can also be used.

The backing used in the present invention has a thickness of 5 to 25 μm and preferably 7 to 15 μm. When the thickness falls within this range, a sufficient insulation property can be ensured, and the function of the rectangular electric wire can be sufficiently exhibited. On the other hand, when the thickness of the backing is 25 μm or less, it is possible to suppress the covering material for a rectangular electric wire from being thick, enabling the wire occupation rate of the coil to be suppressed not to be small when the rectangular electric wire is covered with the covering material, and hence the case where desired coil performance cannot be attained can be reduced; and when the thickness is 5 μm or more, it is possible to suppress the degradation of the insulation property of the wire material and reduce the case where dielectric breakdown occurs during operation.

For the purpose of improving the anchoring capability of the backing used in the present invention with the below described viscoelastic material layer, the backing used in the present invention may be subjected to a chemical treatment such as a sputtering etching treatment, a corona treatment or a plasma treatment, or alternatively may be coated with a primer.

(Viscoelastic Material Layer)

In the present invention, it is preferable to use a viscoelastic material layer having a dynamic elasticity of 1×10³ to 1×10⁸ N/m² in a temperature range from 0 to 80° C., and it is particularly preferable to use a viscoelastic material layer having a dynamic elasticity falling within a range from 1×10⁴ to 1×10⁶ N/m² in the same temperature range. Specifically, the dynamic elasticity of 1×10³ N/m² or more can suppress the increase of the rewinding force (the adhesive force of the self-back surface), can reduce the case where the backing is stretched when the covering material for a rectangular electric wire is rewound from the wound body of the covering material for a rectangular electric wire, and can reduce an adverse possibility that the viscoelastic material layer offers a cause for curling and warping of the electric wire after the covering of the rectangular electric wire covered with the covering material. Such a dynamic elasticity can reduce an adverse possibility that the tape is deformed to have a tape width narrower than the intended tape width. Alternatively, such a dynamic elasticity can reduce an adverse possibility that when the tape is rewound, the so-called blocking phenomenon is caused in which cohesion failure is caused and hence the viscoelastic material adheres to the back surface of the tape. Conversely, the dynamic elasticity of 1×10⁸ N/m² or less can suppress the decrease of the flexibility of the viscoelastic material layer, and hence can reduce an adverse possibility that the workability at the time of attachment of the adhesive tape is hindered.

In the present invention, because of the easiness in establishing the balance of the adhesion property with respect to the adherend (rectangular electric wire), it is desirable that the glass transition temperature (Tg) of the viscoelastic material layer be −5° C. or lower and preferably −10° C. or lower. When the glass transition temperature is −5° C. or lower, it is possible to suppress the possibility that the polymer tends to flow and hence the wettability to the adherend becomes insufficient and it is possible to reduce the case where the adhesive force is decreased.

The viscoelastic material layer of the present invention includes at least a base polymer that constitutes the viscoelastic material. Such a base polymer is not particularly limited, and base polymers appropriately selected from heretofore known base polymers can be used as such a base polymer; examples of such a base polymer include acrylic polymers, rubber-based polymers, vinyl alkyl ether-based polymers, silicone-based polymers, polyester-based polymers, polyamide-based polymers, urethane-based polymers, fluorine-based polymers and epoxy-based polymers. These base polymers may be used each alone or can also be used as mixtures of two or more thereof.

In particular, in the present invention, among these base polymers, the silicone-based polymers can be preferably used because the silicone-based polymers are excellent in cold resistance, radiation resistance, heat resistance and corrosion resistance.

In the present invention, the viscoelastic layer is preferably constituted with a viscoelastic material composition including a silicone-based polymer. The silicone-based viscoelastic material composition includes a cross-linking structure of a mixture mainly composed of a silicone rubber and a silicone resin.

As the silicone rubber, for example, an organopolysiloxane including dimethylsiloxane as a main constitutional unit can be preferably used. A vinyl group or other functional groups may be introduced into the organopolysiloxane, if necessary. The weight average molecular weight of the organopolysiloxane is usually 180,000 or more, preferably 280,000 to 1,000,000 and particularly preferably 500,000 to 900,000. These silicone rubbers can be used each alone or as appropriate combinations of two or more thereof. When the weight average molecular weight is low, the gel fraction can be adjusted by regulating the amount of a cross-linking agent.

It is possible to preferably use, as the silicone resin, for example, an organopolysiloxane made of a copolymer having at least one unit selected from the M unit (R₃SiO_{1/2}), the Q unit (SiO₂), the T unit (RSiO_{3/2}) and the D unit (R₂SiO) (in these units, R represents a monovalent hydrocarbon group or a hydroxy group). The organopolysiloxane made of the copolymer may have one or more OH groups, and additionally, may also have various functional groups such as a vinyl group, as introduced therein, if necessary. The functional groups to be introduced may also be groups to cause cross-linking reactions. As the copolymer, the MQ resin composed of the M unit and the Q unit is preferable.

The mixing ratio (weight ratio) between the silicone rubber and the silicone resin is not particularly limited; however, it is suitable to use the mixture having the ratio of the former:the latter of approximately 100:0 to 20:80, preferably approximately 100:0 to 30:70 and more preferably approximately 80:20 to 40:60. The silicone rubber and the silicone resin may also be used as simply mixed together or may also be used as a partial condensation product between the silicone rubber and the silicone resin.

The aforementioned mixture usually contains a cross-linking agent for the purpose of converting the mixture into a cross-linked structure. The gel fraction of the silicone-based viscoelastic material composition can be regulated with a cross-linking agent.

In the present invention, the gel fraction of the silicone-based viscoelastic material layer varies depending on the type of the silicone-based viscoelastic material composition; it is appropriate that the gel fraction of the silicone-based viscoelastic material layer is generally set at approximately 20 to 99%, preferably approximately 30 to 98% and more preferably approximately 40 to 85%. The gel fraction falling within such a range offers an advantage that it is easy to establish the balance between adhesive force and retention force. When the gel fraction is 99% or less, it is possible to reduce a tendency for the initial adhesive force to be too low and for the adhesion to be degraded; when the gel fraction is 20% or more, a sufficient retention force is obtained, and hence it is possible to reduce the case where the displacement of the covering material or the adhesive protrusion occurs.

The gel fraction (% by weight) of the silicone-based viscoelastic material layer in the present invention can be obtained as follows: a sample of a dry weight W₁ (g) is sampled from the silicone-based viscoelastic material layer and immersed in toluene; then the insoluble matter of the sample is taken out from the toluene; then after drying the weight W₂ (g) of the insoluble matter is measured, and the gel fraction is derived from the formula (W₂/W₁)×100.

The silicone-based viscoelastic material composition in the present invention can use the following generally used cross-linkages: a peroxide curing type cross-linkage due to a peroxide-based cross-linking agent and an addition reaction type cross-linkage due to a Si—H group-containing siloxane-based cross-linking agent.

The cross-linking reaction of the peroxide-based cross-linking agent is a radical reaction, and accordingly the cross-linking reaction is allowed to proceed usually at a high temperature of 150° C. to 220° C. On the other hand, the cross-linking reaction between a vinyl group-containing organopolysiloxane and a siloxane-based cross-linking agent is an addition reaction, and accordingly the reaction usually proceeds at a low temperature of 80° C. to 150° C. In the present invention, the addition reaction-type cross-linkage is preferable particularly from the viewpoint that the cross-linking can be completed at a low temperature in a short period of time.

As the peroxide-based cross-linking agent, various cross-linking agents having hitherto been used for the silicone-based viscoelastic material composition can be used without any particular limitation. Examples of such a peroxide-based cross-linking agent include benzoyl peroxide, t-butylperoxy benzoate, dicumyl peroxide, t-butyl cumyl peroxide, t-butyl oxide, 2,5-dimethyl-2,5-di-t-butylperoxy hexane, 2,4-dichlorobenzoyl peroxide, di-t-butylperoxy-diisopropyl benzene, 1,1-bis(t-butylperoxy)-3,3,5-trimethylcyclohexane and 2,5-dimethyl-2,5-di-t-butylperoxy hexyne-3. These peroxide-based cross-linking agents may be used each alone or can also be used as mixtures of two or more thereof. The used amount of the peroxide-based cross-linking agent is usually approximately 0.15 to 2 parts by weight and more preferably 0.5 to 1.4 parts by weight in relation to 100 parts by weight of the silicone rubber.

As the siloxane-based cross-linking agent, for example, a polyorganohydrogen siloxane having in the molecule thereof at least on average two hydrogen atoms bonded to the silicon atom is used. Examples of the organic group bonded to the silicon atom include an alkyl group, a phenyl group and a halogenated alkyl group; however, from the viewpoint of the easiness in synthesis and handling, a methyl group is preferable. The skeletal structure of siloxane may be any of linear chain, branched chain and annular structures; frequently used among these is a linear chain structure.

The used amount of the siloxane-based cross-linking agent is such that the siloxane-based cross-linking agent is mixed in such a way that the number of the hydrogen atoms bonded to the silicon atoms is 1 to 30 and preferably 4 to 17 in relation to one vinyl group in the silicone rubber and the silicone resin. When the number of the hydrogen atoms bonded to the silicon atoms is one or more, a sufficient cohesive force is obtained; when the number of the hydrogen atoms bonded to the silicon atoms is 30 or less, the tendency for the adhesion property to degrade can be reduced. When the siloxane-based cross-linking agent is used, usually a platinum catalyst is used; however, various other catalysts can also be used. When the siloxane-based cross-linking agent is used, a vinyl group-containing organopolysiloxane is used as the silicone rubber, and the content of the vinyl group is preferably set to be approximately 0.0001 to 0.01 mol/100 g.

Within a range not impairing the advantageous effects of the present invention, for example, the following heretofore known various additives can be appropriately mixed in the viscoelastic material layer of the present invention, in addition to the aforementioned base polymer: a tackifier, a plasticizer, a dispersant, an antiaging agent, an antioxidant, a processing aid, a stabilizer, an antifoaming agent, a flame retardant, a thickener, a pigment, a softener and a filler.

In the present invention, the thickness of the viscoelastic material layer is 1 to 25 μm and preferably 2 to 10 μm. The thickness of the viscoelastic material layer falling within the aforementioned range offers an advantage that appropriate adhesiveness is obtained. On the other hand, when the thickness of the viscoelastic material layer is 25 μm or less, it is possible to suppress the covering material for a rectangular electric wire from being thick, hence it is possible to suppress the wire occupation rate of the coil from being small when the rectangular electric wire is covered with the covering material for a rectangular electric wire, and hence it is possible to reduce the occurrence of the case where desired coil performance cannot be attained. When the thickness of the viscoelastic material layer is 1 μm or more, the adhesion to the wire material is achieved, and hence it is possible to reduce the case where a space is formed in the interface between the wire material and the covering material.

(Covering Material for Rectangular Electric Wire)

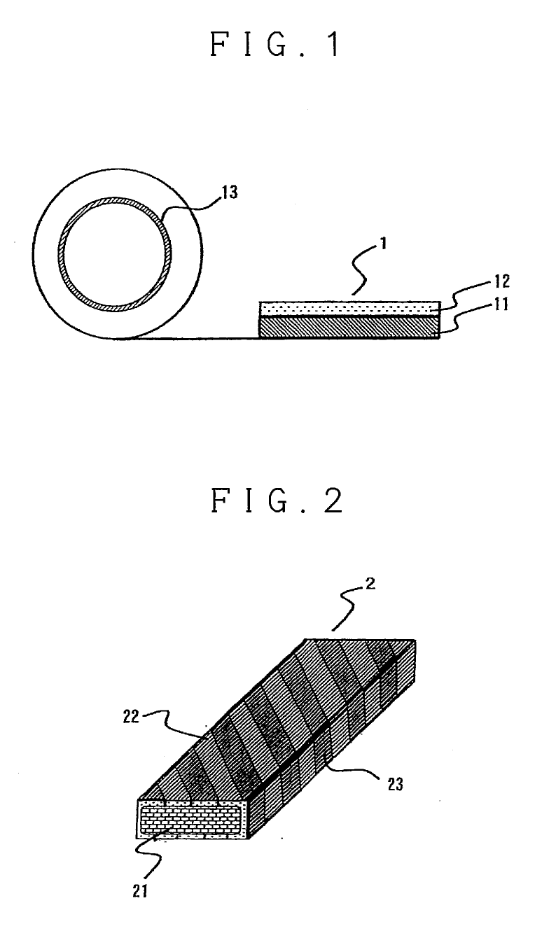

Next, the covering material for a rectangular electric wire of the present invention is described with reference to FIG. 1.

FIG. 1 is a schematic side view illustrating an embodiment of the covering material for a rectangular electric wire of the present invention. In FIG. 1, the rectangular electric wire covering material 1 has a constitution in which a viscoelastic layer 12 is disposed on one side of a backing 11. The rectangular electric wire covering material 1 is wound around a winding core 13 in a roll shape.

The production method of the rectangular electric wire covering material 1 of the present invention is not particularly limited; however, for example, the silicone-based viscoelastic material layer can be formed as the viscoelastic material layer 12 on the backing 11 by a method of covering the backing with the silicone-based viscoelastic material composition.

More Specifically, a solution prepared by dissolving, in a solvent such as toluene, the silicone-based viscoelastic material composition including a silicone rubber, a silicone resin, a cross-linking agent, a catalyst and the like is applied to the backing, and then the mixture is heated to distilled off the solvent and to perform cross-linking. Examples of the formation method of the silicone-based viscoelastic material layer of the present invention include: roll coating, kiss-roll coating, gravure coating, reverse coating, roll brush coating, spray coating, dip roll coating, bar coating, knife coating, air-knife coating, curtain coating, lip coating and extrusion coating using a die coater or the like.

Examples of the formation method of the silicone-based viscoelastic material layer may also include a method in which the silicone-based viscoelastic material layer including the silicone-based viscoelastic material composition is formed on a release liner, and the resulting layer is transferred onto the backing. Examples of the release liner include: paper; films of synthetic resins such as polyethylene, polypropylene and polyethylene terephthalate; and rubber sheet, cloth, non-woven fabric, net, foam sheet and metal foil or laminate sheets of these.

The heating temperature is not particularly limited as long as the solvent can be distilled off and the intended cross-linking reaction proceeds; however, for example, when toluene is used as the solvent and the silicone-based viscoelastic material layer undergoing the addition reaction-type cross-linking is formed, the heating temperature is 80° C. to 150° C. and preferably 100 to 130° C.

The thickness (total thickness) of the rectangular electric wire covering material of the present invention is preferably 0.007 to 0.04 mm, more preferably 0.01 to 0.03 mm and furthermore preferably 0.01 to 0.02 mm. When the thickness of the rectangular electric wire covering material is 0.007 mm or more, the strength of the covering material is sufficient, and it is possible to reduce the case where the covering material is poor in handleability. When the thickness of the rectangular electric wire covering material is 0.04 mm or less, in the case where the rectangular electric wire covered with the rectangular electric wire covering material is wound to form an insulated coil, preferably it is possible to suppress the density decrease of the wire material and to reduce the case where the degradation of the performance is caused.

The general size of commercially available rectangular electric wires is such that the thickness is 1 to 10 mm and the width is 1 to 20 mm; in common insulating covering methods, in many cases, the winding angle falls within a range from 20° to 80°, and the insulating covering material is wound in a half lap so as for the insulating covering material to partially overlap with itself. Accordingly, in consideration of the width of the wire material and the winding angle, the width of the tape is preferably at a minimum approximately equal to and at a maximum approximately twice the width of the wire material. Specifically, the rectangular electric wire covering material of the present invention has a width of preferably 1 to 80 mm, more preferably 1.5 to 60 mm and furthermore preferably 2 to 40 mm.

It is desirable that the rectangular electric wire covering material of the present invention be free from the patching together portion formed when the rectangular electric wire is covered. For that purpose, the rectangular electric wire covering material is preferably a lengthy tape, and it is desirable that the length thereof be 500 m or more, preferably 1000 m or more and furthermore preferably 3000 m or more. Accordingly, the rectangular electric wire covering material 1 of the present invention is wound around the winding core 13 in a roll shape, and the winding manner may be a so-called bobbin winding in which winding is performed in a plurality of rows around a winding core.

It is desirable that the adhesive force (180° peeling, tensile rate: 300 mm/min) to a SUS304 steel plate of the rectangular electric wire covering material of the present invention be 0.01 to 10 N/20 mm, preferably 0.01 to 6.0 N/20 mm, more preferably 0.02 to 4.0 N/20 mm and furthermore preferably 0.1 to 2.0 N/20 mm. The adhesive force of the rectangular electric wire covering material falling within the aforementioned range offers an advantage that the covering material sufficiently adheres to the rectangular electric wire at room temperature to allow the rectangular electric wire to be easily insulation-covered, and the air bubbles and the space can be reduced and a high dielectric breakdown voltage can be attained. On the other hand, the adhesive force of the rectangular electric wire covering material of 10 N/20 mm or less can suppress the difficulty in rewinding, can suppress the stretching of the tape when the tape is spirally wound, and can reduce an adverse possibility that the rectangular electric wire after covering undergoes the warping and twisting. When the adhesive force is 0.01 N/20 mm or more, a sufficient adhesive force to the rectangular electric wire is obtained to reduce an adverse possibility that the space and the air bubbles intervene.

In the present invention, it is preferable that the adhesive force of the rectangular electric wire covering material fall within the aforementioned range, and such an adhesive force can be attained by appropriately regulating the composition of the viscoelastic layer for that purpose. For example, when the silicone-based viscoelastic material composition is used as the viscoelastic material layer, by regulating the mixing ratio between the silicone rubber and the silicone resin, the adhesive force can be regulated; specifically, by increasing the mixing amount of the silicone resin, the adhesive force can be increased. More specifically, when the adhesive force (180° C. peeling, tensile rate: 300 mm/min) of the rectangular electric wire covering material to a stainless steel plate is designed to be 0.01 to 10 N/20 mm, the mixing ratio (weight ratio) between the silicone rubber and the silicone resin may be set to be approximately such that the former:the latter=100:0 to 30:70.

It is also desirable that the rectangular electric wire covering material of the present invention has a low-speed rewinding force (tensile rate: 300 mm/min) of 0.05 to 10 N/20 mm, preferably 0.07 to 7.0 N/20 mm, more preferably 0.1 to 5.0 N/20 mm and furthermore preferably 0.2 to 3.0 N/20 mm. The low-speed rewinding force of the rectangular electric wire covering material falling within the aforementioned range offers an advantage that the rewinding of the rectangular electric wire covering material from the wound body of the rectangular electric wire covering material is performed smoothly. On the other hand, the rewinding force of 5 N/20 mm or less can reduce the case where the rewinding proceeds irregularly.

(Rectangular Electric Wire Covered with Rectangular Electric Wire Covering Material)

The present invention provides a rectangular electric wire covered with the rectangular electric wire covering material. The rectangular electric wire used in the present invention is not particularly limited; heretofore well known rectangular electric wires can be used, and it is possible to use the wire materials made of the materials such as copper, copper alloys, aluminum, aluminum alloys, and combinations of these metals. It is also possible to use rectangular electric wires including various superconducting materials such as a bismuth-based, an yttrium-based and a niobium-based superconducting material.

The method for covering of the rectangular electric wire is not particularly limited; the method may be a heretofore well known method in which the covering adhesive tape (the rectangular electric wire covering material) is spirally wound, or may be a method in which the rectangular electric wire is covered in such a way that the rectangular electric wire runs along the lengthwise direction of the covering adhesive tape (so as to be attached in the longitudinal direction).

It is also desirable to use, as the rectangular electric wire used in the present, a rectangular electric wire having a width/thickness ratio (aspect ratio) in the cross-sectional shape thereof of approximately 1 to 60.

(Electrical Device)

The rectangular electric wire covered with the rectangular electric wire covering material of the present invention can be used in electrical devices such as insulating coils, superconducting coils and superconducting magnets. In particular, the rectangular electric wire covered with the rectangular electric wire covering material of the present invention is free from the air bubbles and the space between the covering material and the wire material and thus has a high dielectric breakdown voltage; accordingly a design involving a large applied electric power is possible in an electrical device using such a covered rectangular electric wire, and consequently, such a covered rectangular electric wire offers an advantage such that high-power devices can be provided.

For example, as shown in FIG. 4, a coil 200 such as an insulating coil or a superconducting coil as an example of the electrical device includes a reel 210 and a rectangular electric wire 100 covered with the rectangular electric wire covering material, wound around the reel 210.

### EXAMPLES

Hereinafter, the present invention is described in more detail on the basis of Examples; however, the present invention is in no way limited by these Examples.

### Example 1

First, 70 parts by weight of “X-40-3229” (silicone rubber, solid content: 60%, manufactured by Shin-Etsu Chemical Co., Ltd.) and 30 parts by weight of “KR-3700” (silicone resin, solid content: 60%, manufactured by Shin-Etsu Chemical Co., Ltd.) as a silicone-based viscoelastic material, 0.5 part by weight of “PL-50T” (manufactured by Shin-Etsu Chemical Co., Ltd.) as a platinum catalyst and 315 parts by weight of toluene as a solvent were mixed together, and the resulting mixture was stirred with a disper to prepare a silicone-based viscoelastic material composition. The silicone-based viscoelastic material composition was applied with a fountain roll onto a backing made of a polyimide resin, “Kapton 40EN” (thickness: 10.0 μm, tensile modulus of elasticity: 5.80 GPa, manufactured by Du Pont-Toray Co., Ltd.) in such a way that the thickness of the silicone-based viscoelastic material composition layer after drying was 3.0 μm, and cured and dried under the conditions of a drying temperature of 150° C. and a drying time of 1 minute, to prepare a rectangular electric wire covering material in which a silicone-based viscoelastic material layer having a gel fraction of 74% was formed on the polyimide resin backing. The obtained rectangular electric wire covering material was taken up onto a winding core (inner diameter: 76 mm) to yield a roll-shaped wound body.

### Example 2

A rectangular electric wire covering material was prepared in the same manner as in Example 1 except that “Kapton 50H” (thickness: 12.5 μm, tensile modulus of elasticity: 3.50 GPa, manufactured by Du Pont-Toray Co., Ltd.) was used as a backing made of a polyimide resin.

### Example 3

A rectangular electric wire covering material in which a silicone-based viscoelastic material layer having a gel fraction of 80% was formed on a polyimide resin backing was prepared in the same manner as in Example 1 except that 60 parts by weight of “X-40-3229” (silicone rubber, solid content: 60%, manufactured by Shin-Etsu Chemical Co., Ltd.) and 40 parts by weight of “KR-3700” (silicone resin, solid content: 60%, manufactured by Shin-Etsu Chemical Co., Ltd.) were used as the silicone-based viscoelastic material. The obtained rectangular electric wire covering material was taken up onto a winding core (inner diameter: 76 mm) to yield a roll-shaped wound body.

### Example 4

A rectangular electric wire covering material in which a silicone-based viscoelastic material layer having a gel fraction of 65% was formed on a polyimide resin backing was prepared in the same manner as in Example 1 except that 50 parts by weight of “X-40-3229” (silicone rubber, solid content: 60%, manufactured by Shin-Etsu Chemical Co., Ltd.) and 50 parts by weight of “KR-3700” (silicone resin, solid content: 60%, manufactured by Shin-Etsu Chemical Co., Ltd.) were used as the silicone-based viscoelastic material. The obtained rectangular electric wire covering material was taken up onto a winding core (inner diameter: 76 mm) to yield a roll-shaped wound body.

### Comparative Example 1

As the backing, “Kapton 50H” (thickness 12.5 μm, manufactured by Du Pont-Toray Co., Ltd.) was used, and the backing was used as it was without disposing any viscoelastic layer thereon.

(Evaluations)

For each of Examples and Comparative Example, the adhesive force, the low-speed rewinding force and the partial discharge onset voltage were respectively measured. The adhesive force and the low-speed rewinding force were measured only for Examples. The results thus obtained are shown in Table 1.

(Measurement of Adhesive Force)

The rectangular electric wire covering material prepared in each of Examples was cut to a width of 20 mm and a length of 150 mm to prepare an evaluation sample. In an atmosphere of 23° C. and 50% RH, the adhesive side of the evaluation sample was bonded to a SUS304 steel plate with the aid of a back and forth movement of a 2-kg roller. After a curing at 23° C. and for 30 minutes, a peeling test was performed by using the universal tensile tester “TCM-1 kNB,” manufactured by Minebea Co., Ltd., at a peeling angle of 180° and a tensile rate of 300 mm/min to measure the adhesive force.

(Measurement of Low-Speed Rewinding Force)

The wound body of the rectangular electric wire covering material prepared in each of Examples was processed by cutting into a wound body of 20 mm in width to be used as a wound body sample for evaluation. A rewinding test was performed to measure the low-speed rewinding force, on the basis of a method according to JIS Z 0237, by using the universal tensile tester “TCM-1 kNB,” manufactured by Minebea Co., Ltd., at a tensile rate of 300 mm/min.

(Measurement of Partial Discharge Onset Voltage)

A specimen of 5 mm in width was prepared from the rectangular electric wire covering material prepared in each of Examples and the backing of Comparative Example, and was wound as shown in FIG. 2 in a spirally covering manner around “Di-BSCCO” (wire material: bismuth-based superconducting wire, 0.23 mm in thickness×4.3 mm in width, manufactured by Sumitomo Electric Industries, Ltd.) as a rectangular electric wire at a winding angle of 60° with the overlap of the rectangular electric wire covering material with itself of approximately 2.0 mm to prepare an evaluation sample 2 of 10 cm in length. In FIG. 2, the rectangular electric wire 21, the specimen 22 (the rectangular electric wire covering material or the backing) and the lap portion 23 of the specimen 22 are shown.

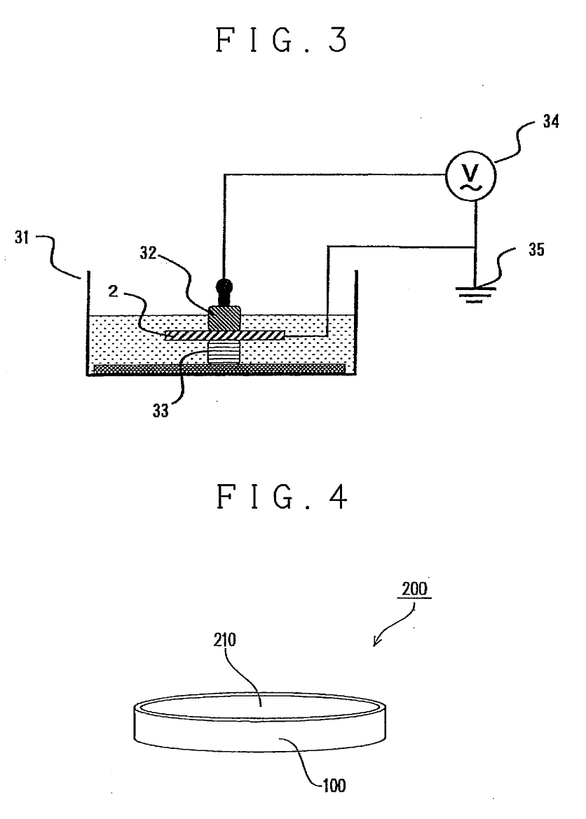

The partial discharge onset voltage in liquid nitrogen was measured with the apparatus shown in FIG. 3. In FIG. 3, a vessel 31, an electrode 32, and a supporting post 33 for holding the evaluation sample 2 and the electrode 32 are shown. In the vessel 31, the evaluation sample 2 was disposed in a manner sandwiching the evaluation sample 2 with the electrode 32 and the supporting post 33. A partial discharge measurement apparatus 34 was connected to the upper electrode 32, and a ground wire 35 was connected to the rectangular electric wire of the evaluation sample 2. Then, liquid nitrogen was added so as for at least the evaluation sample 2 to be immersed in liquid nitrogen, and under the condition that the temperature was stabilized (after an elapsed time of approximately 15 minutes), the measurement was started. The size of the electrode was as follows: 25 mmφ, R 2.5 mm and the contact area 20 mmφ. When the voltage was increased at a voltage increase rate of 200 Vrms/sec, the applied voltage when the discharge of a discharge amount of 100 pC or more occurred at a rate of 50 PPS (the number of the occurrence of discharge per unit time) or more was taken as the partial discharge onset voltage.

TABLE 1

| | | | | | Comparative |
|---|---|---|---|---|---|
| | Example 1 | Example 2 | Example 3 | Example 4 | Example 1 |
| Adhesive force [N/20 mm] | 0.25 | 0.26 | 0.47 | 1.60 | — |
| Low-speed rewinding | 0.85 | 0.88 | 1.20 | 2.10 | — |
| force [N/20 mm] | | | | | |
| Partial discharge | 620 | 700 | 670 | 650 | 310 |
| onset voltage | | | | | |
| [Vrms] | | | | | |

It has been verified that the partial discharge onset voltage of the rectangular electric wire covered with the rectangular electric wire covering material in which the viscoelastic material layer was disposed on the backing as in Examples is a value higher by a factor of two or more as compared to the case where no viscoelastic material was disposed and the rectangular electric wire was covered only with the backing.

### DESCRIPTION OF THE REFERENCE NUMERALS

1 Rectangular electric wire covering material
11 Backing
12 Viscoelastic material layer
13 Winding core
2 Evaluation sample
21 Rectangular electric wire
22 Specimen
23 Lap portion
31 Vessel
32 Electrode
33 Supporting post
34 Partial discharge measurement apparatus
35 Ground wire
100 Rectangular electric wire covered with the rectangular electric wire covering material
200 Coil
210 Reel

1. A covering material for a rectangular electric wire, to cover and insulate a rectangular electric wire therewith, wherein a viscoelastic material layer is disposed on one side of the backing of the covering material.

2. The covering material for a rectangular electric wire according to claim 1, wherein the viscoelastic material layer includes a silicone-based adhesive agent composition.

3. The covering material for a rectangular electric wire according to claim 1, wherein the backing includes a polyimide resin.

4. The covering material for a rectangular electric wire according to claim 1, wherein the adhesive force (180° peeling, tensile rate: 300 mm/min) thereof to a SUS304 steel plate is 0.01 to 10 N/20 mm.

5. The covering material for a rectangular electric wire according to claim 1, wherein the low-speed rewinding force (tensile rate: 300 mm/min) thereof is 0.05 to 10 N/20 mm.

6. A rectangular electric wire covered with a covering material for a rectangular electric wire, wherein the rectangular electric wire is covered with the covering material for a rectangular electric wire according to claim 1.

7. The rectangular electric wire covered with the covering material for a rectangular electric wire according to claim 6, wherein the rectangular electric wire is a superconducting wire.

8. An electrical device using the rectangular electric wire covered with the covering material for a rectangular electric wire according to claim 6.
